(19) United States
(12) Patent Application Publication
(10) Pub. No.: US 2016/0325129 A1
(43) Pub. Date: Nov. 10, 2016

(54) FLUID DISCHARGE NOZZLE

(71) Applicant: International Fog Inc., Seven Valleys, PA (US)

(72) Inventors: Stephen J. JORDAN, Rockville, MD (US); James A. LYNCH, Seven Valleys, PA (US); Andre W. MARSHALL, University Park, MD (US); Noah L. RYDER, Silver Spring, MD (US)

(21) Appl. No.: 14/707,657

(22) Filed: May 8, 2015

(51) Int. Cl. A62C 35/68; B05B 15/00; B05B 3/06

(52) U.S. Cl. CPC A62C 35/68; B05B 3/06; B05B 15/008

(57) ABSTRACT

A rotary fluid discharge nozzle provides uniform distribution of fluid around the nozzle, a flexible fluid distribution pattern and a high discharge coefficient.

### CROSS-REFERENCE TO RELATED APPLICATIONS

Not applicable.

### BACKGROUND OF THE INVENTION

The present invention relates to fluid discharge nozzles and, more particularly, to a rotary fluid discharge nozzle.

Fluid discharge nozzles are used in many applications to convert a higher pressure, slower moving stream of fluid into a lower pressure, faster moving array of droplets to distribute liquid over an area, to increase the surface area of the liquid and/or to alter the force of a liquid impacting a surface. For examples, a fluid discharge nozzle of an agricultural sprayer or an insulation spray gun distributes a fluid over an area larger and/or differing in shape than the conduit through which the fluid is transported to the nozzle. Dust control systems commonly incorporate nozzles to distribute water and/or chemicals over surfaces to prevent particles from becoming airborne and/or to produce a large volume of small airborne droplets to suppress dust that has become airborne.

Likewise, the nozzles of a fire suppression system disperse the stream of fire suppressant, commonly water, in a supply conduit to increase the surface area to which the suppressant is applied, increase the surface area of the suppressant and control the force with which the suppressant impacts a surface. Dispersing a stream of water as a mist of droplets increases the surface area of the water promoting more rapid heating of the water and conversion of the water to steam. When converted to steam each pound (0.45 kg) of water absorbs 1150 Btu. (0.34 kW), cooling the surface of burning material and inhibiting the production of flammable vapors. In addition, when steam envelops the fire area, the steam absorbs products of combustion reducing smoke and displacing oxygen to aid in extinguishing the fire. The impacts of water droplets on the surface of oil or other non-water soluble liquids mechanically agitate the surface reducing its flammability and may even render the surface inflammable

Fluid discharge nozzles typically comprise a housing which defines a fluid passageway that includes one or more orifices. The housing also typically includes a portion enabling connection of the housing to a supply conduit which in the case of fire suppression sprinklers is commonly iron pipe. When fluid flows from the supply conduit through the orifice the fluid's velocity increases and its pressure decreases and the liquid stream evolves into liquid lamina. Downstream of the orifice, instability induced by aerodynamic forces first break the lamina into substantially cylindrical elongate ligaments and then into droplets that spread outward from the orifice. Fire suppression sprinklers often include a deflector to further facilitate dispersal of the fluid. The deflector is supported in fluid exiting the orifice(s), typically, by a projecting portion of the housing. The deflector may be rotatable by the impinging fluid stream or it may be stationary. The deflector aids breaking the liquid lamina from the orifice into sheets that radiate from the sprinkler. However, the inherent turbulence and the shadows created by the deflector and the projecting portion of the housing typically causes the fluid to be unevenly distributed by the sprinkler requiring additional sprinklers and piping to compensate for the unequal distribution of fluid.

Preferably, a fluid discharge nozzle, such as a fire suppression sprinkler, will have a high discharge coefficient enabling the sprinkler to operate satisfactorily with a moderate supply pressure. However, the portion of a nozzle's fluid passageway having smallest cross-section, typically the orifice(s), produces the major portion of the pressure drop for the nozzle and limits the nozzles efficiency.

What is desired is an efficient fluid discharge nozzle that more evenly disperses the fluid around the nozzle.

### BRIEF DESCRIPTION OF THE DRAWINGS

FIG. 1 is an elevation drawing of a rotary fluid discharge nozzle.

FIG. 2 is a section drawing of the fluid discharge nozzle of FIG. 1 taken along line A-A.

FIG. 3 is a section drawing of the fluid discharge nozzle of FIG. 1 taken along line B-B.

FIG. 4 is an elevation drawing of a second exemplary rotary fluid discharge nozzle.

FIG. 5 is an elevation drawing of a third exemplary rotary fluid discharge nozzle.

FIG. 6 is a schematic drawing of fluid distribution from an exemplary vertical rotary fluid discharge nozzle.

FIG. 7 is a plan view of a spheroidal rotor for a rotary fluid discharge nozzle.

FIG. 8 is an elevation view of the spheroidal rotor of FIG. 7.

FIG. 9 is an section view of the spheroidal rotor of FIG. 7 taken along line A-A.

### DETAILED DESCRIPTION OF PREFERRED EMBODIMENTS

Fire suppression sprinklers are one of many applications for high performance fluid discharge nozzles. There are several basic types of fire suppression sprinkler systems. The piping of a wet sprinkler system is filled with pressurized water which is retained in the piping by closed sprinklers. When a sensor in a sprinkler is exposed to heat, the sprinkler opens to release the fire suppressant, commonly water. If the sprinkler system is exposed to freezing temperatures antifreeze may be added to the supply piping or a dry sprinkler system may be used. The supply piping of a dry sprinkler system is typically filled with pressurized air or nitrogen which is released when a heat sensor in one of the sprinklers opens the sprinkler. The decreasing pressure of the gas in the piping causes a valve to open and supply water to the sprinklers. Typically, a preaction sprinkler system is used in applications where valuable property could be damaged by water from the sprinklers. Similar to a dry system, the piping of a preaction sprinkler system does not contain water while the air in the supply conduit may or may not be pressurized. A preaction valve operable by a fire detection system supplies water to the sprinklers when a fire is detected. When a sensor element in one of the sprinklers detects excessive heat, that sprinkler opens and discharges fire suppressant.

A deluge sprinkler system is often used in industrial and commercial applications, such as power plants, substations, chemical processing facilities and aircraft hangers, where fire hazards are high and where the spread of a fire would be costly or dangerous. Typically, the sprinkler heads of a deluge system are open and connected to dry piping. The dry piping is connected to a source of fire suppressant, typically water, by a deluge valve which is controlled by a fire detection system. When the fire detection system detects a fire, typically by sensing smoke, radiation, excessive heat or a combination thereof, the deluge valve is activated producing a rush of water to the open deluge sprinkler heads to blanket the entire hazard and smother the fire before it can spread.

To attain the high volumes of water characteristic of deluge sprinkler systems at reasonable supply pressures the sprinkler heads are preferably characterized by a high discharge coefficient. The discharge coefficient or “K-factor” is a mathematical constant established by the sprinkler's manufacturer which relates the flow of water that can be expected from a sprinkler at a given pressure. The discharge coefficient is used to calculate the discharge rate of nozzles for water based fire protection systems including sprinklers, water mist, hose reel and deluge systems. The K-factor equals the ratio of the flow rate of water through the nozzle to the square root of the pressure supplied to the nozzle, that is:

K=Q/√P Eq. 1

where: K=discharge coefficient

Q =fluid flow rate in gallons/minute or liters/minute

P=supply pressure in respectively psig, bar or kiloPacals (kPa)

1 K (gal./min.Xpsi^{1/2})=14.4 K (liters/min.X bar^{1/2})=1.44 K (liters/min.XkPa^{1/2}) Eq. 2

The discharge coefficient of a typical nozzle is limited by the size of the orifice necessary to produce the desired pattern of droplets. The inventors reasoned that a fluid discharge nozzle having a plurality of orifices which rotate around the axis of the nozzle as the fluid is discharged could have a high discharge coefficient and produce a more uniform distribution of droplets around the nozzle than prior nozzles.

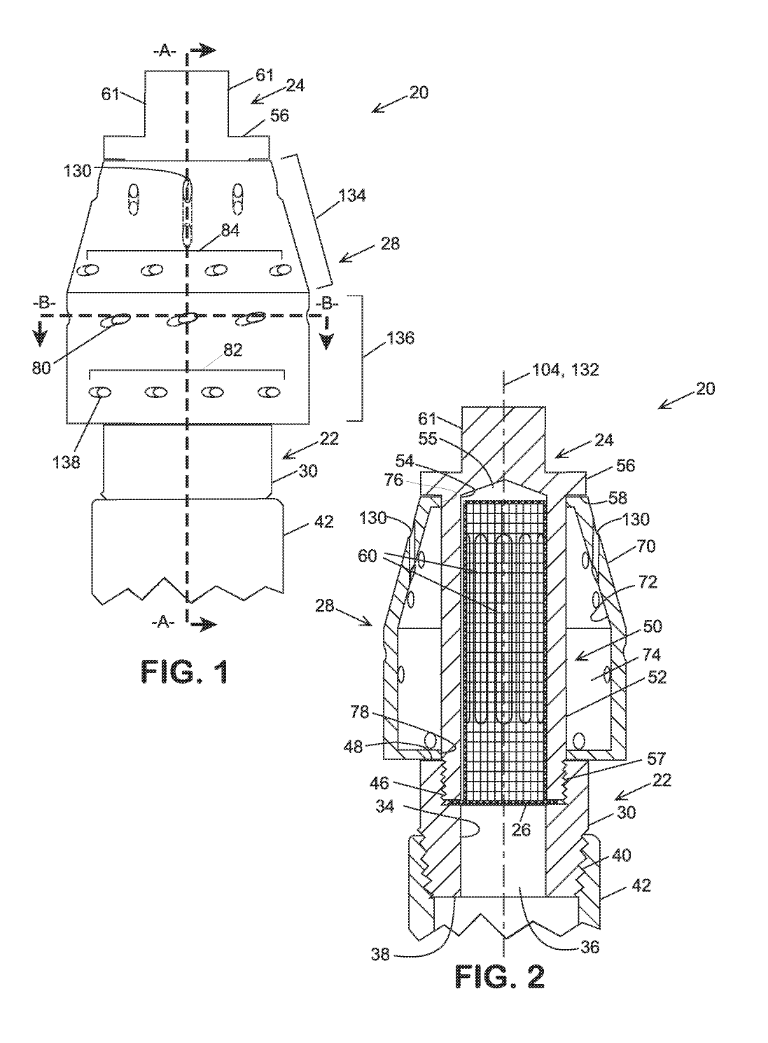

Referring in detail to the drawings where similar parts are identified by like reference numerals, and, more particularly to FIGS. 1 and 2, an exemplary rotary fluid discharge nozzle 20 comprises, generally, a base 22, a nozzle head 24, a screen 26 and a rotor, for example the rotor 28.

The tubular base 22 has a wall 30 with an internal surface 34 which defines a fluid passage 36 extending the length of the base and an external surface. A portion of the base 22 proximate a first end 38 defines a supply connection 40 enabling joining of the base to a fluid supply conduit 42. The supply connection 40 may define external pipe threads enabling connection of the base to a pipe coupling portion of the supply conduit 42 or may define internal pipe threads to enable connection to a threaded pipe or pipe nipple (not shown). On the other hand, the supply connection 40 may define a portion of another piping connector or a connector for another type of supply conduit, by way of examples only, a flare fitting, an o-ring fitting, a compression fitting or a hose fitting. Threads 46 of one gender or a portion of another fluid tight connector are also defined on a second portion of the wall 30 proximate the second end 48 of the base 22 to enable connection of the base to the nozzle head 24.

The nozzle head 24 includes a tubular first portion 50 extending axially from one end of the nozzle head and having a wall defining an external surface 52 and an internal surface 54 which defines a fluid passage 55 communicatively connectable to the fluid passage 36 in the base 22. One end of the first portion 50 of the nozzle head 24 is terminated by a cap 56 which blocks the fluid passage 55 and extends outward from the external surface 52 of the first portion 50 to form a bearing surface 58 for the rotor. The cap 56 may include portions defining wrench flats 61 to facilitate engagement and disengagement of threaded connections between the nozzle head 24 and the base 22 and/or between the base and the supply conduit 42. At the end of the nozzle head 24 distal of the cap 56, the nozzle head is connected to the base 22, for example by threads 57 defined on the exterior surface 50 of the wall which are engageable with threads 46 of the opposite gender defined on the wall of the base 22.

The wall of the first portion 50 of the nozzle head 24 defines at least one aperture 60 connecting the internal surface 54 and the external surface 52 of the wall. Fluid flowing through fluid passage 36 in the base 22 and into the nozzle head 24 can flow out of the nozzle head through the aperture(s). Preferably, the aperture(s) 60 comprises plural elongate slots having a large combined area enabling high flow rates through the base 22 and the nozzle head 24 with minimal pressure drop.

A screen, for example a basket screen 26 in the fluid passageway 36, 55 captures contaminates in the fluid.

A rotor, for example, the rotor 28, rotatably engages the external surface 52 of the tubular portion 50 of the nozzle head 24 and is constrained axially between the bearing surface 58 of the nozzle head's cap 56 and an end surface 48 of the base 22. Generally, a rotor comprises a wall, typically of metal or a high performance composite, such as aramid fiber reinforced epoxy, having an external surface, for example, external surface 70, and an internal surface, for example, internal surface 72. Referring also to FIG. 9, an axially central portion 73 (indicated by a bracket) of the internal surface 72 preferably has a dimension greater than the diameter of the external surface 52 of the tubular portion 50 of the nozzle head 24 creating an annular space 74 between the internal surface of the central portion 73 of the rotor and the external surface 52 of the tubular portion of the nozzle head 24. The surface of the rotor wall includes bearing portions 76, 78 proximate each end of the rotor which define apertures having a diameter only slightly larger than the external diameter of the tubular portion 50 of the nozzle head 24 enabling rotation of the rotor about the tubular portion of the nozzle head. Under pressure, fluid flows from the supply conduit 42 through the respective internal passages 36, 55 of the base and the nozzle head then through the aperture(s) 60 in the wall of the nozzle head 24 and into the annular space 74 between the external surface 52 of the tubular section of the nozzle head and the interior surface 72 of the rotor.

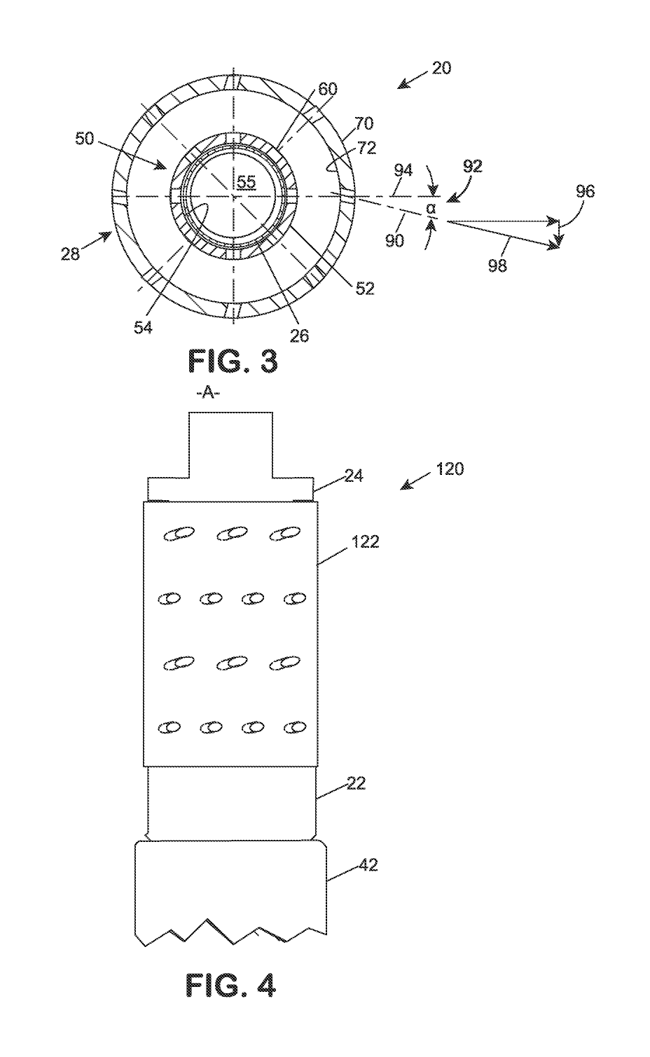

The wall of the rotor defines plural orifices, for example, orifice 80, that accelerate the fluid, reduce the fluid's pressure, and control the direction of the fluid as it flows through the rotor's wall from the annular space 74. The orifices are typically equally spaced around the periphery of the rotor's wall in one or more rings of orifices which are spaced axially apart on the rotor, for example rings 82 and 84 (indicated by brackets). Referring also to FIG. 3, the longitudinal centerline 90 of each orifice may be skewed at a respective first angle (∀) 92 to an intersecting radius, for example, radius 94, of the rotor to impart a tangential component 96 to the direction vector 98 of the fluid stream from the respective orifice. Each fluid stream is a reaction mass and similar to the exhaust of a rocket or jet engine exerts a force on the rotor in a direction opposite of the stream's direction vector 98. The tangential components 96 of the various direction vectors urge rotation of the rotor on the nozzle head 24. The first angle (∀) is preferably about 30 degrees as measured between the centerline, for example centerline 90, of the respective orifice and a respective an intersecting radius, for example intersecting radius 94, but could be a greater or lesser angle for respective orifices.

Referring also to FIG. 6, the longitudinal centerline of each orifice, for example, centerline 90, is also oriented at a respective angle (N) 102 relative to the longitudinal axis 104 of the rotor to impart in the respective fluid stream's direction vector 98 direction components parallel 108 and normal 110 to the longitudinal axis 132 of the nozzle 20, which is coincident with the longitudinal axis of the rotor. For a vertical nozzle, that is a nozzle mounted with the longitudinal centerline 132 arranged vertically, rotation of the rotor evenly distributes the fluid from each orifice around a respective annular area, for example annular area 116, centered on the longitudinal axis 132 of the nozzle 20. The dimensions and location relative to the longitudinal axis of the nozzle of each annular contact area is determined by the water pressure, distance from the orifice to the surface, the shape of the orifice and the angle (N) 102 of the stream's direction vector 98 relative to the nozzle's longitudinal centerline. Although gravity increasingly distorts the pattern as distance from the nozzle increases, there is a similar distribution of fluid proximate a horizontal nozzle enabling the discharge of a substantially vertical wall of suppressant.

Distribution of fluid by the nozzle is facilitated by rotation of the rotor without the necessity of a large pressure drop in the nozzle's orifice(s). Referring also to FIG. 4 an exemplary nozzle 120 with a cylindrical rotor 122 provides a wide angle spray with a nominal k-factor equal or exceeding 10 liters/min.XkPa^{1/2}.

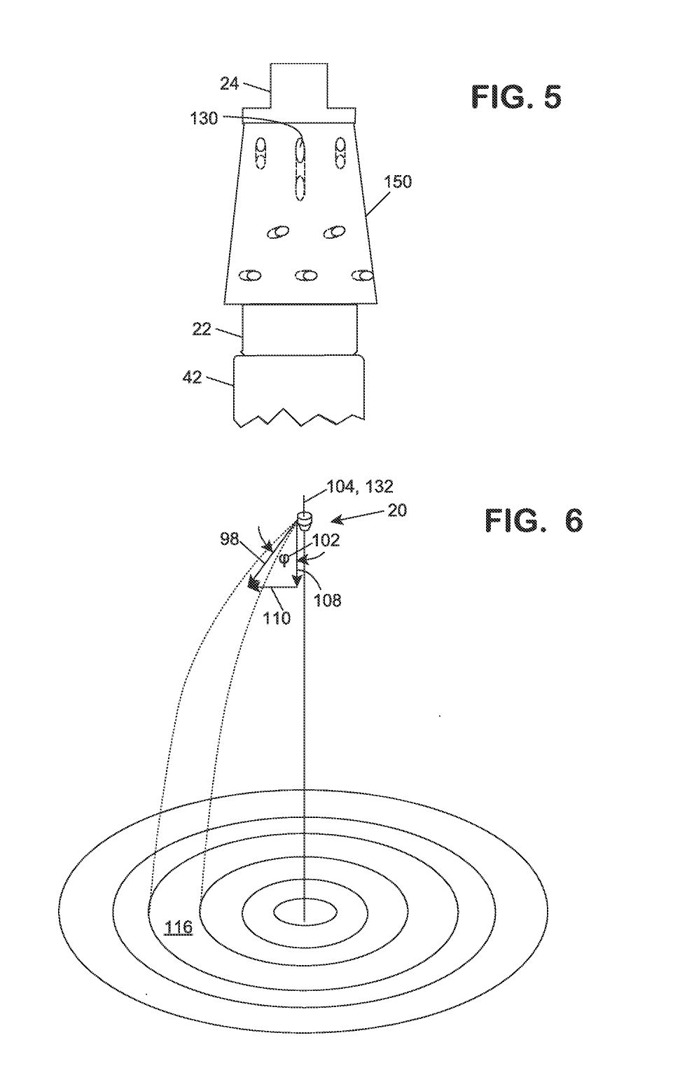

The pattern of dispersal can be changed by altering the shape of the rotor and the arrangement of orifices. In rotors of appropriate shape, the angle (N) may be any angle between zero and 180 degrees. For example, referring to also FIG. 5, a frustoconical rotor 150 or a rotor such as the exemplary rotor 28 which includes a frustoconical surface portion 134 (indicated by a bracket) may include orifices 130 with longitudinal axes extending substantially parallel to the longitudinal axis 104 of the rotor enabling a portion of the fluid discharged by the nozzle to be directed toward the intersection of the longitudinal axis of the nozzle and a surface. Fluid may also directed substantially radially by other orifices, for example, orifice 138, in a cylindrical portion 136 of the nozzle 28 to provide a wide dispersal area. An exemplary 1.5 inch (0.038 m) diameter rotary nozzle, such as nozzle 20, with a frustoconical rotor, such rotor 28, may have a nominal K-factor equivalent to or exceeding 9.0 liters/min.XkPa^{1/2}.

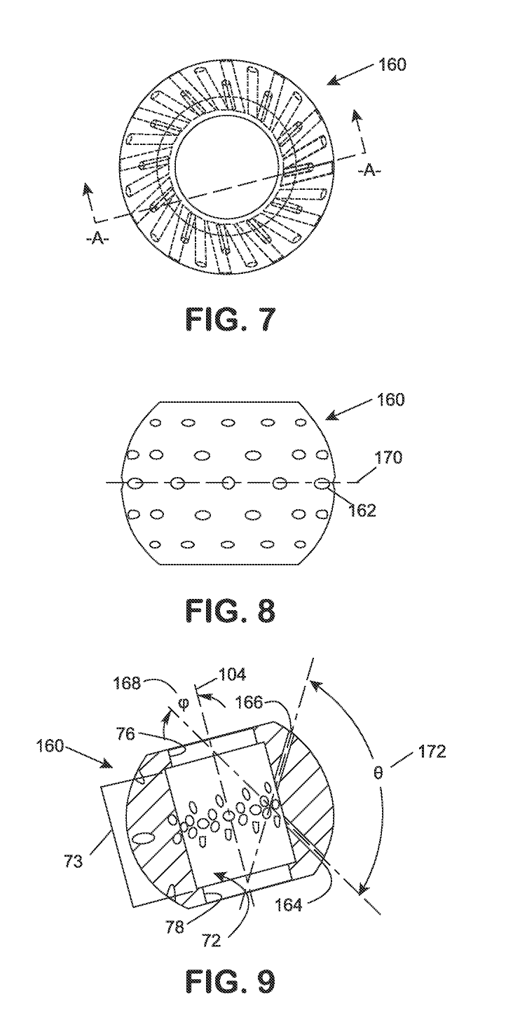

Referring also to FIGS. 7 and 8, a spheroid rotor 160 may include orifices, such as orifice 162, having a centerline arranged at a second angle substantially normal (N=90 degrees) to the longitudinal axis 104 of the nozzle and orifices, such as orifices 164, 166, arranged to direct fluid 168 in both directions relative nozzle's equator 170. Preferably, the centerline of the orifice 164 is arranged at an acute second angle (N) 168, for example, approximately thirty degrees, to the longitudinal axis 104 of the rotor and the centerline of the orifice 166 is arranged at an obtuse angle (2) 172, for example one hundred and twenty degrees, to the centerline of orifice 164.

The rotary fluid discharge nozzle provides substantially uniform distribution of fluid, a flexible distribution pattern and a high discharge coefficient useful in many applications. By way of example, the K-factor may be within a range of substantially 0.25 to a range of substantially 30, depending on its size.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A fluid discharge nozzle comprising:
(a) a nozzle head including:
(i) a tubular first portion having a wall with an interior surface defining a fluid passageway, an exterior surface and defining at least one aperture connecting the interior surface and the exterior surface, the nozzle head connectable to a supply conduit; and
(ii) an end cap closing one end of the fluid passageway;
(b) a rotor arranged for rotation on the first portion of the nozzle head and defining at least one orifice having a central axis arranged at a first angle to a radius of the rotor and at a second angle to the longitudinal axis of the rotor.

2. The fluid discharge nozzle of claim 1 wherein the rotor further comprises an outer surface defining frustrum of a cone.

3. The fluid discharge nozzle of claim 2 wherein a central axis of at least one orifice is arranged at a second angle of substantially zero degrees to the longitudinal axis of the rotor.

4. The fluid discharge nozzle of claim 1 wherein the rotor further comprises an outer surface including a first portion defining a frustrum of a cone and a second portion defining a cylinder.

5. The fluid discharge nozzle of claim 4 wherein a central axis of at least one orifice in the first portion of the rotor is arranged at a second angle of substantially zero degrees to the longitudinal axis of the rotor.

6. The fluid discharge nozzle of claim 4 having a K-factor equivalent to at least 9.0 liters per minute kiloPascal^{1/2}.

7. The fluid discharge nozzle of claim 1 wherein the rotor further comprises an outer surface defining a cylinder.

8. The fluid discharge nozzle of claim 7 having a K-factor equivalent to at least 10 liters per minute kiloPascal^{1/2}.

9. The fluid discharge nozzle of claim 1 wherein the rotor further comprises an outer surface defining a spheroid.

10. The fluid discharge nozzle of claim 9 wherein the rotor further defines a first orifice having a central axis arranged at an acute angle to the longitudinal axis of the rotor and a second orifice with a central axis arranged at an obtuse angle to the central axis of the first orifice.

11. A fluid discharge nozzle comprising:
(a) a base defining a base fluid passage and having a connecting portion arranged for connection to a fluid supply conduit;
(b) a nozzle head including;
(i) a tubular first portion having a wall with an exterior surface, an interior surface and defining at least one aperture connecting the interior surface and the exterior surface, the first portion of the nozzle head arranged for connection to the base with the base fluid passage in communication with a nozzle head fluid passage defined by the interior surface; and
(ii) an end cap closing an end of the nozzle head fluid passage;
(c) a screen arranged to block passage of a contaminant through the aperture in the wall of the first portion of the nozzle head; and
(d) a rotor comprising an interior surface defining plural, axially spaced apart bearing surfaces arranged to engage the exterior surface of the tubular first portion of the nozzle head for rotation of the rotor thereon and an axially central cavity having a dimension greater than a dimension of the exterior surface of the first portion of the nozzle head and an exterior surface and defining plural orifices each connecting the exterior surface and the axially central cavity and each having a central axis arranged at a respective first angle to a radius of the rotor and at a respective second angle to a longitudinal axis of the rotor.

12. The fluid discharge nozzle of claim 11 wherein the exterior surface of the rotor defines a frustrum of a cone.

13. The fluid discharge nozzle of claim 12 wherein a central axis of at least one orifice is arranged at a second angle of substantially zero degrees to the longitudinal axis of the rotor.

14. The fluid discharge nozzle of claim 11 wherein a first portion of the exterior surface of the rotor defines a frustrum of a cone and a second portion of the exterior surface defines a cylinder.

15. The fluid discharge nozzle of claim 14 wherein a central axis of at least one orifice in the first portion of the rotor is arranged at a second angle of substantially zero degrees to the longitudinal axis of the rotor.

16. The fluid discharge nozzle of claim 15 wherein a central axis of at least one orifice in the second portion of the rotor is arranged at a substantially normal second angle to the longitudinal axis of the rotor.

17. The fluid discharge nozzle of claim 14 having a K-factor equivalent to at least 9.0 liters per minute kiloPascal^{1/2}.

18. The fluid discharge nozzle of claim 11 wherein the exterior surface of the rotor defines a cylinder.

19. The fluid discharge nozzle of claim 18 having a K-factor equivalent to at least 10 liters per minute kiloPascal^{1/2}.

20. The fluid discharge nozzle of claim 11 wherein the exterior surface of the rotor defines a spheroid.

21. The fluid discharge nozzle of claim 20 wherein a first orifice has a central axis arranged at an acute second angle to the longitudinal axis of the rotor and a second orifice has a central axis arranged an obtuse angle to the central axis of the first orifice.

22. The fluid discharge nozzle of claim 11 wherein the first angle is acute.
